(19) United States
(12) Patent Application Publication
(10) Pub. No.: US 2020/0096408 A1
(43) Pub. Date: Mar. 26, 2020

(54) Systems And Methods For Managing A Cable Attached To An Inspection Probe Disposed In A Pressurized Pipe

(71) Applicant: Hydra-Stop LLC, Burr Ridge, IL (US)

(72) Inventors: Christopher C. Vazzana, Palos Park, IL (US); Andrew J. Nelson, Chicago, IL (US)

(73) Assignee: Hydra-Stop LLC, Burr Ridge, IL (US)

(21) Appl. No.: 16/576,295

(22) Filed: Sep. 19, 2019

Related U.S. Application Data
(60) Provisional application No. 62/733,956, filed on Sep. 20, 2018.

(51) Int. Cl. G01M 3/00

(52) U.S. Cl. CPC G01M 3/005

(57) ABSTRACT

Systems and methods are disclosed for managing a cable attached to an inspection probe disposed in a pipe containing a fluid at an elevated pressure above an ambient pressure. The systems and methods include hot-tapping the pipe and attaching a launch housing to the pipe. The launch housing defines an interior chamber sized to receive the inspection probe and that fluidly communicates with the pipe, thereby placing the interior chamber at the elevated pressure. An uphole end of the cable is attached to a reel, and a cable drive mechanically engages the cable. The cable drive is operable in a forward direction, to advance the cable into the pipe, and a reverse direction, to retract the cable from the pipe.

### FIELD

The present disclosure generally relates to pressurized pipe inspection, and more particularly to systems and methods for driving a cable attached to an inspection probe disposed in a pressurized pipe.

### BACKGROUND

Pressurized conduits or pipes convey fluids, both liquid and gas, in municipalities, industrial plants, and commercial installations. When originally installed, a network of pipes typically includes strategically located isolation valves or block valves, which are used to isolate certain downstream sections of the pipe for repairs, relocation, and installation of new components into the pipe. When repair or maintenance of a pipe used in a municipal water system is required, however, inoperable isolation valves may need to be replaced, and the locations of existing isolation valves may necessitate the installation of additional isolation valves.

A hot tapping procedure may be used during pipe repair or maintenance to minimize service disruption. In a hot tapping procedure, a new access point into the pipe is formed while the fluid inside the pipe remains at an operable pressure. For example, commonly assigned U.S. Pat. Nos. 8,627,843 and 9,644,779 disclose methods of installing additional gate valves in pressurized pipes that do not require service interruption and result in minimal fluid or pressure loss. The additional gate valves connect to the pipe as an assembly using a permanent housing known as a valve housing that is sealably clamped to the pipe and normally extends upward. A temporary gate valve is sealably mounted on the open top of the valve housing (i.e., the distal end of the valve housing). One or more “tap” or installation housings and a tapping machine are mounted on top (distal end) of the temporary gate valve for delivering a cutting device through the temporary gate valve to the proximal end of the valve housing to cut a hole or “coupon” in the exposed pipe. After removal of the cutting device and closure of the temporary gate valve, the same or similar installation housings are mounted on the distal end of the temporary gate valve for delivering the gate valve cartridge through the temporary gate valve and to the interior of the valve housing, where it is housed while in the open position. This procedure is accomplished without depressurizing the pipe.

Instead of adding a gate valve to a pipe that may remain as a permanent fixture as disclosed in the '843 and '779 patents, sometimes all that is desired is to stop the flow through the pipe just upstream of a repair or maintenance location without installing a gate valve. In this case, a line stop is used to temporarily isolate the pipe at or upstream of the site of the repair or maintenance, while keeping the remainder of the system in operation. Similar to the '843 and '779 patents, commonly assigned U.S. Pat. No. 6,810,903 discloses a system that includes the use of a line stop fitting mounted to the pipe and a temporary gate valve mounted on top of the line stop fitting. Using appropriate housings and a tapping machine mounted on top of the temporary gate valve, a cutting device is inserted through the temporary gate valve to cut an opening in the pipe. After removal of the cutting device and closure of the temporary gate valve, a pump and ram with a housing are used to insert a line stop through the temporary gate valve and line stop fitting and into the pipe temporarily (see FIGS. 1-16 of the '903 patent) to stop the flow through the pipe. After a temporary line stop is withdrawn through the temporary gate valve, a completion plug is inserted through the temporary gate valve and into the line stop fitting to seal the line stop fitting so the temporary gate valve may be removed (see FIG. 16 of the '903 patent).

Separately or simultaneous with such repair and maintenance procedures, pipe diagnostics and condition assessment may be performed using inspection probes deployed into the pipe while maintained under working pressure. Such inspection probes, which include crawlers, drones, or other types of devices, typically include a cable carrying communication lines for transmitting control signals, camera feeds, or other types of information. The cable is attached at one end to the inspection probe, extends through a portion of the pressurized pipe, and passes through a sealing orifice at an access point to the surrounding environment. The sealing orifice engages the cable with a sealing force sufficient to prevent substantial leakage of working fluid through the orifice, creating a friction force that resists movement of the cable in either direction. Additionally, a portion of the cable that is fed into the pipe when the inspection probe is advanced must be chlorinated to prevent contamination of the working fluid.

### SUMMARY

In accordance with one aspect of the present disclosure, a system is provided for managing a cable attached to an inspection probe disposed in a pipe containing a fluid at an elevated pressure above an ambient pressure. The system includes a launch housing defining an interior chamber sized to receive the inspection probe, the launch housing including a first end fluidly communicating with the pipe, thereby to place the interior chamber at the elevated pressure, and a second end closed off by an end plate. The end plate defines a sealing orifice extending through the end plate and sized to sealingly engage an intermediate section of the cable. A reel is disposed outside of the launch housing and adapted to secure an uphole end of the cable. A cable drive disposed inside the interior chamber of the launch housing and is configured to mechanically engage the intermediate section of the cable, the cable drive being operable to advance the cable in opposite forward and reverse directions.

In accordance with another aspect of the present disclosure, an alternative system is provided for managing a cable attached to an inspection probe disposed in a pipe containing a fluid at an elevated pressure above an ambient pressure. The alternative system includes a launch housing defining an interior chamber sized to receive the inspection probe, the launch housing including a first end fluidly communicating with the pipe, thereby to place the interior chamber at the elevated pressure, and a second end opposite the first end. A reel is supported for rotation and disposed within an enclosure maintained at the elevated pressure, the reel coupled to an uphole end of the cable, wherein the reel rotates in opposite first and second directions, thereby to advance the cable in forward and reverse directions.

In accordance with a further aspect of the present disclosure, a method is provided of managing a cable attached to an inspection probe disposed in a pipe containing a fluid at an elevated pressure above an ambient pressure. The method includes hot-tapping the pipe, attaching a launch housing to the pipe, the launch housing defining an interior chamber sized to receive the inspection probe and fluidly communicating with the pipe, thereby to place the interior chamber at the elevated pressure, securing an end of the cable to a reel, and mechanically engaging the cable with a cable drive, wherein the cable drive is operable in a forward direction, to advance the cable into the pipe, and a reverse direction, to retract the cable from the pipe.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a side elevation view, in cross-section, of a first embodiment of a system for managing a cable attached to an inspection probe disposed inside a pipe under pressure, according to the present disclosure.

FIG. 2 is an enlarged detail view, in cross-section, of a portion of the system of FIG. 1.

FIG. 3 is an enlarged side view of a cable drive usable in the system of FIG. 1.

FIG. 4 is a side elevation view, in cross-section, of a second embodiment of a system for managing a cable attached to an inspection probe disposed inside a pipe under pressure, according to the present disclosure.

FIG. 5 is an enlarged perspective view, in partial cross-section, of the system of FIG. 4.

FIG. 6 is a side elevation view, in partial cross-section, of a third embodiment of a system for managing a cable attached to an inspection probe disposed inside a pipe under pressure, according to the present disclosure.

It should be understood that the drawings are not necessarily drawn to scale and that the disclosed embodiments are sometimes illustrated schematically. It is to be further appreciated that the following detailed description is merely exemplary in nature and is not intended to limit the invention or the application and uses thereof. Hence, although the present disclosure is, for convenience of explanation, depicted and described as certain illustrative embodiments, it will be appreciated that it can be implemented in various other types of embodiments and in various other systems and environments.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

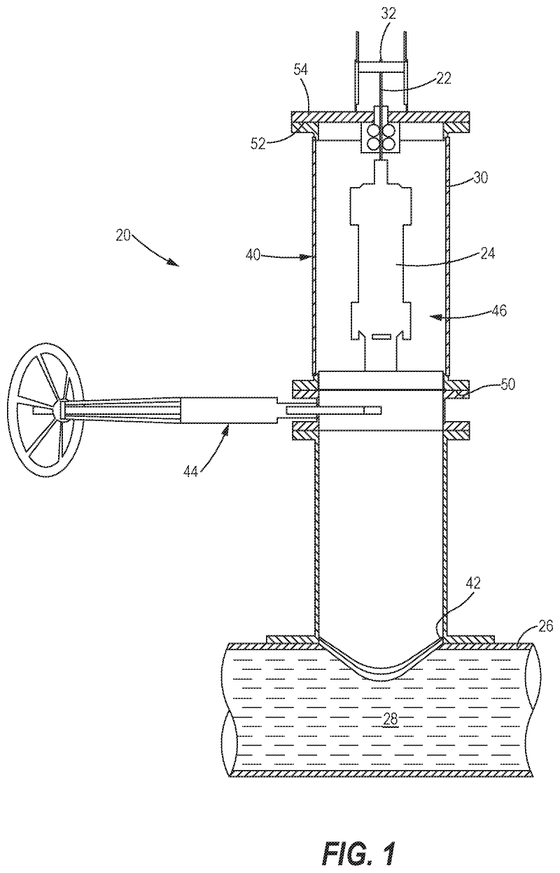

FIGS. 1-3 illustrate a first embodiment of a system 20 for managing a cable 22 attached to an inspection probe 24. The inspection probe 24 is particularly suited for use inside a pipe 26 containing a fluid 28 disposed at an elevated pressure above an ambient pressure present outside of the pipe 26. As used herein, the term “inspection probe” is intended to cover any tethered tool or device that is intended for use inside a pressurized pipe for inspecting, dimensioning, cleaning, or other operation. The inspection probe 24 may include one or more sensors configured to measure or detect a characteristic of the pipe 26 or the fluid 28 in the pipe 26, such as pressure transducers, Hall effect sensors, and ultrasonic sensors. The cable 22 has a downhole end 30 coupled to the inspection probe 24 and an uphole end 32 that is adjustably secured in place to position the inspection probe 24 as desired.

The system 20 includes a launch housing 40 in which the inspection probe 24 may be initially stored. The launch housing 40 is mounted onto a horizontal section of the pipe 26 and over a hole or opening 42 that previously has been cut into the top surface of the pipe 26, as described in the '843, and '779 patents cited above. A temporary gate valve 44 may be provided between the launch housing 40 and the pipe 26 to permit selective fluid communication between the pipe 26 and an interior chamber 46 defined by the launch housing 40. The interior chamber 46 is sized to receive an entirety of the inspection probe 24, thereby to provide an enclosure that protects the inspection probe 24 prior to deployment.

More specifically, the launch housing 40 may include a first end 50 in fluid communication (via an open gate valve 44, if provided) with the pipe 26, thereby to place the interior chamber 46 at the elevated pressure of the fluid 28 in the pipe 26. A second end 52 of the launch housing 40 is located opposite the first end 50, and is closed off by an end plate 54. A sealing orifice 56 extends through the end plate 54 and is sized to sealingly engage an intermediate section 22a of the cable 22 extending between the downhole end 30 and the uphole end 32. For example, the sealing orifice 56 may include a seal 58 configured to form a water-tight seal with the cable 22.

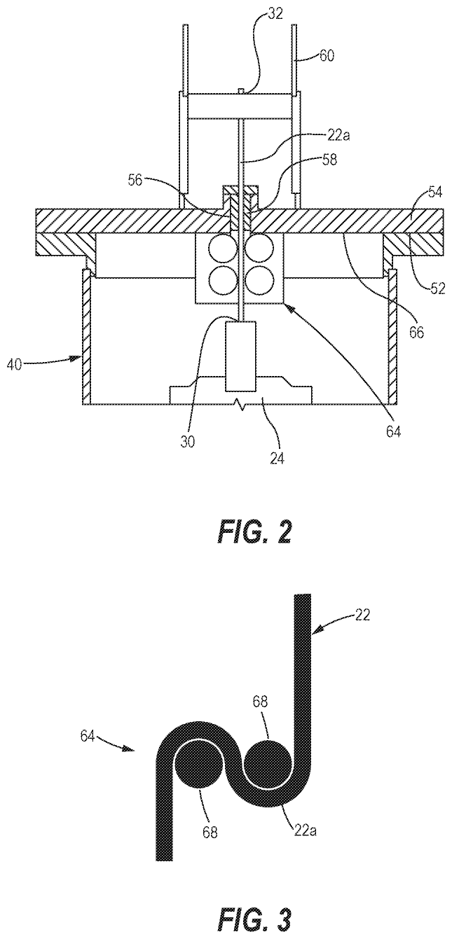

The system 20 further includes a reel 60 for winding and unwinding the cable 22. As best shown in FIG. 2, the reel 60 may be disposed outside of the launch housing 40 and coupled to the uphole end 32 of the cable 22. As illustrated, the reel 60 is mounted directly to the end plate 54, however the reel 60 may be provided at other locations outside of the launch housing 40. The reel 60 may be journally supported for rotation in both a first direction, which unwinds the cable 22 to advance the inspection probe 24 in a downhole direction, and an opposite second direction, which winds the cable 22 to retract the inspection probe 24 in an uphole direction.

The system 20 may also include a cable drive 64 which provides a force that advances the cable 22 in the downhole direction or retracts the cable 22 in the uphole direction. As best shown in FIG. 2, the cable drive 64 is disposed inside the interior chamber 46 of the launch housing 40 and disposed between the reel 60 and the inspection probe 24, such as coupled to an interior face 66 of the end plate 54. In this embodiment, the cable drive 64 is configured to directly, mechanically engage the intermediate section 22a of the cable 22. For example, in the embodiment illustrated in FIG. 3, the cable drive 64 may include a pair of rollers 68 that are spaced to pinch the cable 22 therebetween. The rollers 68 may be operable in a forward direction, thereby to advance the cable 22 in the downhole direction, and a reverse direction, thereby to retract the cable 22 in the uphole direction.

Various types of cable drives 64 may be employed in the system 20. For example, the cable drive 64 may be an electric drive, in which an electrically driven motor provides the force for operating the cable drive 64. Alternatively, the cable drive 64 may be a mechanical or manual drive.

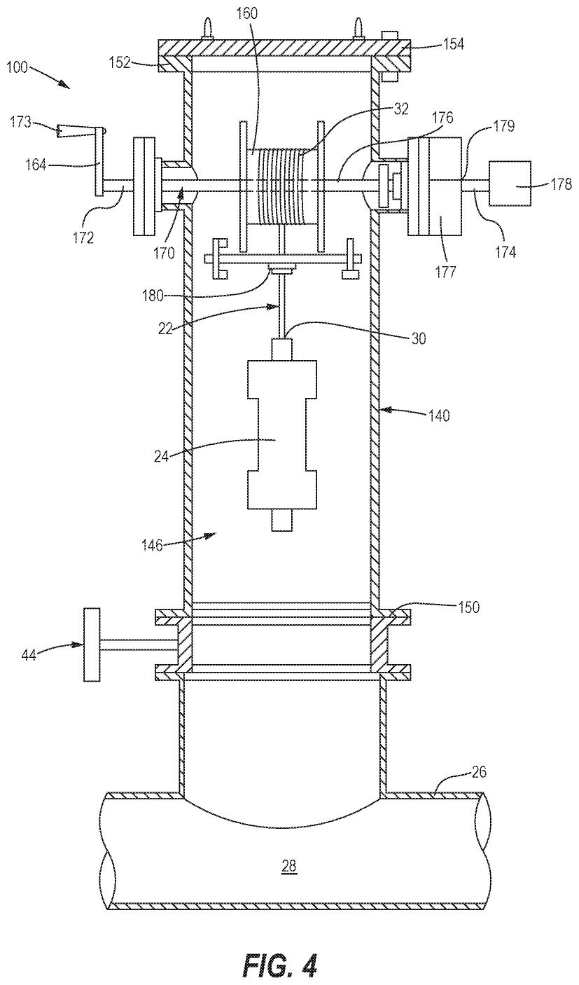

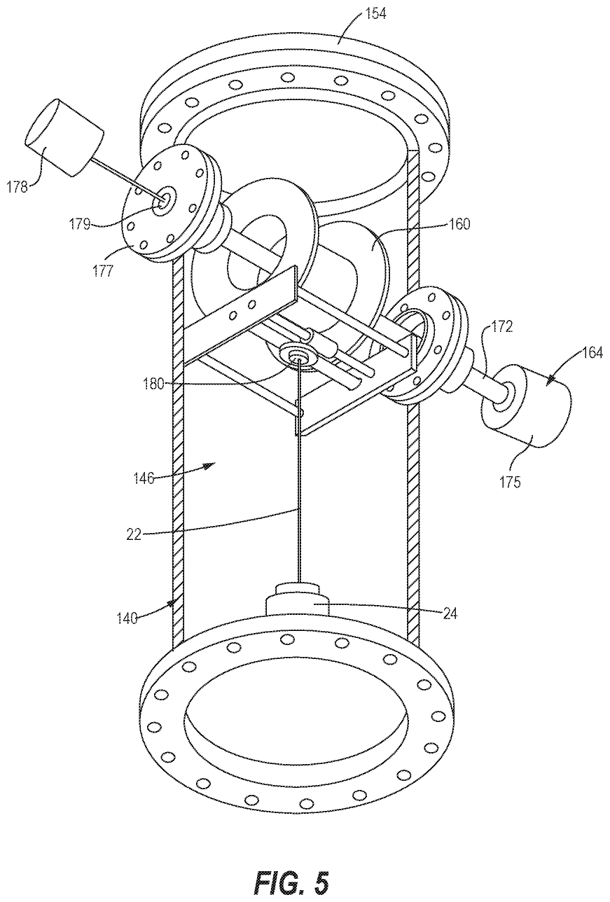

An alternative embodiment of a system 100 for managing a cable 22 is illustrated in FIGS. 4 and 5. While the system 100 of FIGS. 4 and 5 is similar to the system 20 of FIGS. 1-3, one primary difference is that the system 100 includes a reel disposed inside an interior chamber of a launch housing. Locating the reel within the interior chamber eliminates the possibility of introducing contaminants on the cable (thereby removing the need to treat the cable with chlorine or other disinfectant) and avoids any issues associated with the cable traversing a large pressure differential.

The system 100 is also provided for managing the cable 22 attached to the inspection probe 24. The system 100 includes a launch housing 140 in which the inspection probe 24 may be initially stored. The launch housing 140 is mounted onto a horizontal section of the pipe 26. The temporary gate valve 44 may be provided between the launch housing 140 and the pipe 26.

More specifically, the launch housing 140 may include a first end 150 in fluid communication (via an open gate valve 44, if provided) with the pipe 26, thereby to place the interior chamber 146 at the elevated pressure of the fluid 28 in the pipe 26. A second end 152 of the launch housing 140 is located opposite the first end 150, and is closed off by an end plate 154.

The system 100 further includes a reel 160 for winding and unwinding the cable 22. As best shown in FIG. 5, the reel 160 may be disposed inside an interior chamber 146 of the launch housing 140 and coupled to the uphole end 32 of the cable 22. As illustrated, the reel 160 is mounted on a rotatable shaft 170 that extends through the launch housing 140. The shaft has first and second shaft ends 172, 174 disposed outside of the launch housing 140, and an intermediate shaft portion 176 disposed within the interior chamber 146. The reel 160 is coupled to the intermediate shaft portion 176. The reel 160 is supported to rotate in both a first direction, which unwinds the cable 22 to advance the inspection probe 24 in a downhole direction, and an opposite second direction, which winds the cable 22 to retract the inspection probe 24 in an uphole direction.

A cable drive 164 may be operably coupled to the reel 160, thereby to provide the force that advances the cable 22 in the downhole and uphole directions. As best shown in FIG. 4, the cable drive 164 is coupled the first shaft end 172 and is provided as a manual drive having a handle 173 that may be engaged by a user to manually rotate the reel 160. In FIG. 5, the cable drive 164 is schematically illustrated as an electric drive having a motor 175 coupled to the firsts shaft end 172 and configured to rotate the reel 160.

The system 100 may further include an electrical interface 177 coupled to the cable 22 to operably connect the cable 22 to a controller 178 for the inspection probe 24. As best shown in FIGS. 4 and 5, the electrical interface 177 may be provided as a slip ring coupled to the second shaft end 174. On one end of the slip ring, wire strands of the cable 24 operably engage contacts provided on the slip ring. The contacts are electrically coupled to a fixed electrical connector 179 provided on the slip ring. The connector 179 may be coupled to the controller 178, thereby to transfer power, control signals, feedback signals, or other electrical or communication signals between the controller 178 and the inspection probe 24 via the cable 22.

The system 100 may also include a cable guide 180 to better control the winding and unwinding of the cable 22 on the reel 160. As shown in FIGS. 4 and 5, the cable guide 180 is positioned between the reel 160 and the inspection probe 24. In the illustrated embodiment, the cable guide 180 is mounted to an interior surface of the launch housing 140, so that the entire cable guide assembly (including mounting brackets) is disposed within the interior chamber 146. Alternatively, the mounting brackets may extend through the wall of the launch housing.

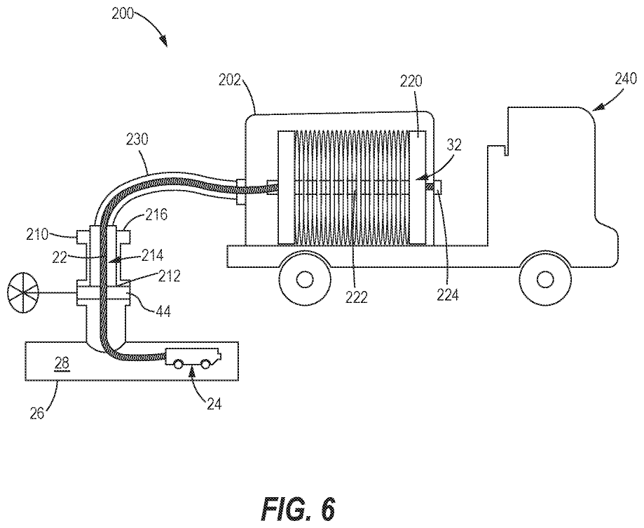

A further embodiment of a system 200 for managing a cable 22 is illustrated in FIG. 6. While the system 200 of FIG. 6 is similar to the system 20 of FIGS. 1-3 and the system 100 of FIGS. 4 and 5, one primary difference is that the system 200 includes an external pressurized vessel 202 provided separate from the pipe 26 in which a reel 204 is disposed for controlling deployment of the inspection probe 24. Locating the reel 204 within the external pressurized chamber 202 eliminates the possibility of introducing contaminants on the cable (thereby removing the need to treat the cable with chlorine or other disinfectant) and avoids any issues associated with the cable traversing a large pressure differential. Additionally, it minimizes or eliminates the need for a launch housing, permitting use in confined spaces.

As best shown in FIG. 6, the system 200 manages the cable 22 attached to the inspection probe 24. In the illustrated embodiment, the system 100 includes a launch housing 210 in which the inspection probe 24 may be stored initially. The launch housing 210 is mounted onto a horizontal section of the pipe 26, and the temporary gate valve 44 may be provided between the launch housing 210 and the pipe 26. More specifically, the launch housing 210 may include a first end 212 in fluid communication (via open gate valve 44, if provided) with the pipe 26, thereby to place an interior chamber 214 of the launch housing 210 at the elevated pressure of the fluid 28 in the pipe 26. A second end 216 of the launch housing 210 is located opposite the first end 212.

The system 200 further includes a reel 220 for winding and unwinding the cable 22. As best shown in FIG. 6, the reel 160 is disposed inside the external pressurized chamber 202 and coupled to the uphole end 32 of the cable 22. As illustrated, the reel 220 is mounted on a rotatable shaft 222 to rotate in both a first direction, which unwinds the cable 22 to advance the inspection probe 24 in a downhole direction, and an opposite second direction, which winds the cable 22 to retract the inspection probe 24 in an uphole direction. A cable drive 224 may be operably coupled to the reel 160, thereby to provide the force that advances the cable 22 in the downhole and uphole directions.

A sheath 230 fluidly couples the external pressurized vessel 202 to the launch housing 210, so that the external pressurized vessel 202 has the same fluid pressure as the pipe 26. In some embodiments, the sheath 230 is sized to permit passage of the cable 22, while in other embodiments the sheath 230 is sized to permit passage of the cable 22 and probe 24. While the external pressurized vessel 202 is shown mounted on a transport vehicle 240, it will be appreciated that the pressurized vessel 202 may be provided without the vehicle.

According to additional aspects of this disclosure, a method is provided of managing a cable 22 attached to an inspection probe 24 disposed in a pipe 26 containing a fluid 28 at an elevated pressure above an ambient pressure. The method may include hot-tapping the pipe 26 and attaching a launch housing to the pipe. The launch housing defines an interior chamber sized to receive the inspection probe and fluidly communicates with the pipe, thereby to place the interior chamber at the elevated pressure. The method further includes securing an end of the cable to a reel and mechanically engaging the cable with a cable drive, wherein the cable drive is operably in a forward direction, to advance the cable into the pipe, and a reverse direction, to retract the cable from the pipe. The reel may be located in the ambient environment outside of the pressurized pipe 26 (as shown in the embodiment of FIGS. 1-3), inside the pressurized pipe 26 (as shown in the embodiment of FIGS. 4-5), or inside an external pressurized vessel that is separate from the pressurized pipe 26 connected by an outer sheath to the pressurized pipe 26 (as shown in the embodiment of FIG. 6).

In some embodiments, the method includes closing off an access end of the launch housing with an end plate, wherein the end plate defines a sealing orifice sized to sealingly engage an intermediate portion of the cable. In this embodiment, the reel is positioned outside of the launch housing and the cable drive is positioned within the interior chamber of the launch housing and between the end plate and the inspection probe.

In other embodiments, the method includes providing a rotatable shaft extending through the launch housing to define first and second shaft ends disposed outside of the launch housing and an intermediate shaft portion disposed within the interior chamber. In this embodiment, the reel is coupled to the intermediate shaft portion so that the reel is disposed within the interior chamber, and the cable drive is coupled to the reel.

All references, including publications, patent applications, and patents, cited herein are hereby incorporated by reference. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. Additionally, aspects of the different embodiments can be combined with or substituted for one another. Finally, the description herein of any reference or patent, even if identified as “prior,” is not intended to constitute a concession that such reference or patent is available as prior art against the present disclosure.

What is claimed is:

1. A system for managing a cable attached to an inspection probe disposed in a pipe containing a fluid at an elevated pressure above an ambient pressure, the system comprising:
a launch housing defining an interior chamber sized to receive the inspection probe, the launch housing including a first end fluidly communicating with the pipe, thereby to place the interior chamber at the elevated pressure, and a second end closed off by an end plate, the end plate defining a sealing orifice extending through the end plate and sized to sealingly engage an intermediate section of the cable;
a reel disposed outside of the launch housing and adapted to secure an uphole end of the cable; and
a cable drive disposed inside the interior chamber of the launch housing and configured to mechanically engage the intermediate section of the cable, the cable drive being operable to advance the cable in opposite forward and reverse directions.

2. The system of claim 1, in which the cable drive comprises an electric drive.

3. The system of claim 1, in which the cable drive comprises a mechanical drive.

4. The system of claim 1, in which the cable drive is manually operable.

5. The system of claim 1, in which the sealing orifice comprises a seal configured to form a water-tight seal with the cable.

6. The system of claim 5, further comprising an electrical interface coupled to the uphole end of the cable and providing a fixed electrical connector.

7. The system of claim 1, further comprising a gate valve disposed between the first end of the launch housing and the pipe.

8. A system for managing a cable attached to an inspection probe disposed in a pipe containing a fluid at an elevated pressure above an ambient pressure, the system comprising:
a launch housing defining an interior chamber sized to receive the inspection probe, the launch housing including a first end fluidly communicating with the pipe, thereby to place the interior chamber at the elevated pressure, and a second end opposite the first end; and
a reel supported for rotation and disposed within an enclosure maintained at the elevated pressure, the reel coupled to an uphole end of the cable, wherein the reel rotates in opposite first and second directions, thereby to advance the cable in forward and reverse directions.

9. The system of claim 8, in which the enclosure comprises the launch housing, the system further including a rotatable shaft extending through the launch housing to define first and second shaft ends disposed outside of the launch housing and an intermediate shaft portion disposed within the interior chamber, wherein the reel is coupled to the intermediate shaft portion so that the reel is disposed within the interior chamber.

10. The system of claim 9, further comprising an electric drive operably coupled to the first shaft end.

11. The system of claim 8, in which the enclosure comprises an external pressurized vessel fluidly coupled to the second end of the launch housing by a sheath.

12. The system of claim 8, further comprising a gate valve disposed between the first end of the launch housing and the pipe.

13. A method of managing a cable attached to an inspection probe disposed in a pipe containing a fluid at an elevated pressure above an ambient pressure, the method comprising:
hot-tapping the pipe;
attaching a launch housing to the pipe, the launch housing defining an interior chamber sized to receive the inspection probe and fluidly communicating with the pipe, thereby to place the interior chamber at the elevated pressure;
securing an uphole end of the cable to a reel; and
mechanically engaging the cable with a cable drive, wherein the cable drive is operable in a forward direction, to advance the cable into the pipe, and a reverse direction, to retract the cable from the pipe.

14. The method of claim 13, in which:
an end plate closes off an access end of the launch housing and defines a sealing orifice sized to sealingly engage an intermediate portion of the cable;
the reel is positioned outside of the launch housing; and
the cable drive is positioned within the interior chamber of the launch housing and between the end plate and the inspection probe.

15. The method of claim 13, in which:
a rotatable shaft extends through the launch housing to define first and second shaft ends disposed outside of the launch housing and an intermediate shaft portion disposed within the interior chamber;
the reel is coupled to the intermediate shaft portion so that the reel is disposed within the interior chamber; and
the cable drive is coupled to the reel.

16. The method of claim 13, in which the reel is disposed in an external pressure vessel fluidly coupled to the launch housing by a sheath.

17. The method of claim 13, in which the cable drive comprises an electric cable drive.

18. The method of claim 13, further comprising a cable guide configured to engage a portion of the cable.

19. The method of claim 18, in which the cable guide is disposed in the interior chamber of the launch housing.

20. The method of claim 13, further comprising inserting a gate valve between the launch housing and the pipe.
